(19) United States
(12) Patent Application Publication
(10) Pub. No.: US 2016/0266292 A1
(43) Pub. Date: Sep. 15, 2016

(54) Coatable Polymer Polarizer

(71) Applicant: Light Polymers Holding, Grand Cayman (KY)

(72) Inventors: Valeriy Kuzmin, San Bruno, CA (US); Evgeny Morozov, Burlingame, CA (US); Liudmila Yazykova, San Bruno, CA (US)

(73) Assignee: Light Polymers Holding, Grand Cayman (KY)

(21) Appl. No.: 15/054,900

(22) Filed: Feb. 26, 2016

Related U.S. Application Data
(60) Provisional application No. 62/132,735, filed on Mar. 13, 2015.

(51) Int. Cl. G02B 5/30; C09K 19/38; C08G 73/06; C08G 73/10; C09D 179/08

(52) U.S. Cl. CPC G02B 5/3016; C08G 73/1067; C09D 179/08; C08G 73/0688; C09K 19/3823

(57) ABSTRACT

A coatable polymer polarizer may be formed with a composition that includes a rigid rod-like polymer capable of forming a liquid crystal phase in a solvent. The rigid rod-like polymer may form an achromatic polarizer.

### BACKGROUND

Light consists of electromagnetic fields that oscillate in a direction perpendicular to the direction of propagation. Unpolarized light is the most general case of light polarization, and linear, elliptical, and circular polarizations are specific cases. Linearly polarized light is the case where electromagnetic fields oscillate in a plane, and this plane is defines the polarization plane. One can convert polarization from linear polarization to circular or elliptical polarization. Polarized light may be used in a variety of optical devices in general and display devices in particular.

A polarizer is an optical filter that passes light of a specific polarization and blocks waves of other polarizations. It can convert a beam of light of undefined or mixed polarization into a beam with well-defined polarization, polarized light. The common types of polarizers are linear polarizers and circular polarizers. Polarizers are used in many optical techniques and instruments, and polarizing filters find applications in photography and liquid crystal display technology.

Current polarizer technology utilizes a polarizing film formed of a polyvinyl alcohol type resin layer having a dichroic material impregnated therein. Such known technologies include a method wherein a polyvinyl alcohol type resin layer is formed by coating and drying a solution of polyvinyl alcohol type resin on a resin substrate and then subjecting this resin layer to a stretching process, and then subjecting the stretched resin substrate to a dyeing process to form a polarizing film having a dichroic material impregnated therein in a molecularly oriented state. Alternatively, a method includes forming a polyvinyl alcohol type resin layer and applying a dichroic material therein, and then stretching the dyed resin layer to form a polarizing film having the dichroic material impregnated therein in a molecularly oriented state.

A liquid-crystal display element can have a polarizing film (described above) laminated on each of a front and back surfaces of a liquid-crystal cell. The polarizing film typically has a thickness of at least 20 micrometers. These polarizing films typically include additional barrier layers to maintain the dimensional stability of the polarizing film but add thickness to the polarizing film element.

Improvements in polarizer technology are desired.

### SUMMARY

The present disclosure relates to a coatable polymer polarizer. The coatable polymer polarizer may be formed with a composition that includes a rigid rod-like polymer capable of forming a liquid crystal phase in a solvent. The rigid rod-like polymer may form an achromatic polarizer.

In one aspect, a composition includes a rigid rod-like polymer capable of forming a liquid crystal phase in a solvent. The rigid rod-like polymer includes a conjugated molecular segment (I), having a first conjugation length; and a bridging group in between adjacent conjugated molecular segments along a main chain of the rigid rod-like polymer. A conjugation length of the rigid rod-like polymer is greater than the first conjugation length. The segment (I) is represented by a structure:

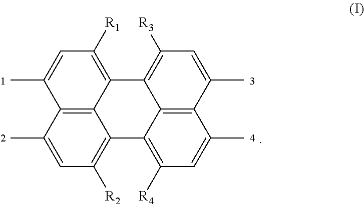

Each of R₁, R₂, R₃ and R₄ is independently, hydrogen or a substituent group that renders the rigid rod-like polymer soluble in a solvent and the bridging groups are connected to the conjugated molecular segment (I) at positions 1, 2, 3, and 4.

In another aspect, a polarizer includes a layer of aligned polymer material formed from a lyotropic liquid crystal material. The layer of aligned polymer material transmitting most of visible light of a first polarization and absorbing most of visible light having a second polarization orthogonal to the first polarization. The layer has a thickness of less than five micrometers. The aligned polymer material may be achromatic.

In a further aspect, an article includes a substrate and the polarizer, described herein, disposed on the substrate.

In another aspect, a method of forming an achromatic polarizer includes the steps of shear coating a lyotropic liquid crystal polymer material onto a substrate to form an aligned liquid crystal polymer layer, and drying the aligned liquid crystal polymer layer to form a layer of aligned polymer material layer. The aligned polymer material layer transmitting most of visible light of a first polarization and absorbing most of visible light having a second polarization orthogonal to the first polarization. The aligned polymer material layer having a thickness of less than five micrometers. The aligned polymer material may be achromatic. In some embodiments the coating is be done on flat surface of a substrate or a device. In another embodiment the surface is curved.

These and various other features and advantages will be apparent from a reading of the following detailed description.

### BRIEF DESCRIPTION OF THE DRAWING

The disclosure may be more completely understood in consideration of the following detailed description of various embodiments of the disclosure in connection with the accompanying drawings; in which:

FIG. 1 is schematic diagram of an illustrative polarizing article;

FIG. 2 is a schematic diagram of another illustrative polarizing article;

FIG. 3 is a graph of the transmittance spectra in a parallel and perpendicular orientation for Example 1; and

FIG. 4 is a graph of the dichroic ratio verses wavelength for Example 1.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

In this disclosure:

“visible light” refers to light wavelengths generally from about 400 nm to about 800 nm;

“achromatic” refers to color-less;

“rigid rod-like polymer” refer to a polymer that does not easily bend, this term is generally understood in the polymer field;

“alkyl” is a linear or branched carbon chain having from one to a specified number of carbon atoms;

“alkoxy” is an ether substituent group that is near or branched carbon chain having from one to a specified number of carbon atoms.

The present disclosure relates to a coatable polymer polarizer. The coatable polymer polarizer may be formed with a composition that includes a rigid rod-like polymer capable of forming a liquid crystal phase in a solvent. The rigid rod-like polymer may form an achromatic polarizer. The coatable polymer polarizer may be formed from a lyotropic liquid crystal material solution coated onto a substrate to create a layer of aligned polymer material transmitting most visible light of a first polarization and absorbing most visible light having a second polarization (generally orthogonal to the first polarization). This coatable polymer polarizer may be achromatic and appear clear, black or grey. This coatable polymer polarizer may have a thickness of less than five micrometers or less than one micrometer. The aligned polymer material may be formed by shear coating the lyotropic liquid crystal material onto a substrate. The lyotropic liquid crystal material can be coated directly onto an optical element such as a glass substrate of a LCD panel. The optical element may be a planar surface or a curved surface. While the present disclosure is not so limited, an appreciation of various aspects of the disclosure will be gained through a discussion of the examples provided below.

The aligned polymer coatings are prepared from lyotropic liquid crystal solutions exhibiting a nematic phase. Nematic liquid crystal molecules tend to have orientational alignment with respect to other nematic liquid crystal molecules whereby the liquid crystal molecules directors tend to align in parallel, but nematic liquid crystal molecules do not have positional order.

An aligned polymer material layer has extended electron conjugation system similar to what can be found in dyestuff molecules. In case of the polymer the conjunction system is stretched in primarily one direction. This material will thus absorb visible light and absorption coefficients for light polarized in different directions will depend on anisotropy of polarizability of the polymer chains.

The aligned rigid rod-like polymer layer may be described as achromatic or having an appearance that lacks strong chromatic content. The aligned rigid rod-like polymer layer may be described as having a neutral color. A neutral color has a chroma=0, hue is undefined. Pure neutral colors include black, white and all grays.

The aligned polymer material layer, formed from the coatable rigid rod-like polymers described herein, may have a dichroic ratio of at least 50 or at least. This aligned polymer material layer may have a polarization efficiency of at least 99.9% or at least 99.99% or at least 99.995%. This aligned polymer material layer may have a transmittance (single layer) of at least 40% or at least 43% or at least 45%.

In this disclosure the anisotropic structure of liquid crystal molecules is utilized. These liquid crystal molecules have rigid rod-like polymer main chains and are soluble in either water or organic solvents. An aligned polymer layer is obtained by shear coating from these lyotropic liquid crystal solutions. In some cases, water-soluble polymers are used. In other cases, organic solvent-based polymers are used.

A method of forming an achromatic polarizer includes the steps of shear coating a lyotropic liquid crystal polymer material onto a substrate to form an aligned liquid crystal polymer layer and drying the aligned liquid crystal polymer layer to form a layer of aligned polymer material layer. The aligned polymer material layer transmits most of visible light of a first polarization and absorbing most of visible light having a second polarization orthogonal to the first polarization. The aligned polymer material layer having a thickness of less than 10 micrometers or less than five micrometers or less than one micrometer.

Shear coating methods include slot coating, slit coating, doctor blade coating, die coating, slot-die coating, gravure coating, micro-gravure coating, curtain coating and the like. After the shear coating step, the coated solution is dried to remove the solvent and form a polarizer coating or layer of an aligned polymer material. Light absorption depends upon the conjugation length of the polymer and the alignment of most or all of the polymers, preferentially along an alignment direction, i.e., the direction along which most or all of the polymer chains are aligned. For linearly polarized light, the light absorption is a maximum for linear polarization along the alignment direction. In many embodiments, the alignment direction coincides with the shear coating direction.

The coatable polymer polarizer may be coated directly onto a substrate or an optical element. The substrate or an optical element may be primed and/or corona treated to improve adhesion of the coatable polymer polarizer to the surface of the substrate or an optical element. The coatable polymer polarizer may be coated to have the rigid rod-like polymer align parallel with the edges of the substrate or an optical element (e.g., along the coating or machine direction). In other embodiments the coatable polymer polarizer may be coated to have the rigid rod-like polymer align at an angle with the edges of the substrate or an optical element. In some embodiments this angle with the edges can be 22.5 degrees or 45 degrees.

The contrast ratio is the ratio of the transmission of linearly polarized light perpendicular to the alignment direction to the transmission of linearly polarized light parallel to the alignment direction. The contrast ratio depends on coating conditions and on anisotropy of polarizability of the molecule. The polarizability anisotropy depends upon the ratio of the extent of the conjugated electronic system along the polymer chain to that of the in-plane direction perpendicular to the polymer chain. In order to improve the contrast ratio of the polarizer, the uniformity of the alignment of the polymer chains along the alignment direction is increased and the electronic anisotropy is increased.

The coatable polymer polarizer layer has a reduced thickness as compared to conventional polarizers. The coatable polymer polarizer layer may have a thickness of less than 10 micrometers, or less than 5 micrometers, or less than 3 micrometers, or less than 2 micrometers, or less than 1 micrometer, or less than 750 nm. In many embodiments the polarizer layer has a thickness in a range from about 100 nm to 5000 nm or from about 250 nm to 1000 nm or from about 250 nm to 750 nm or about 500 nm.

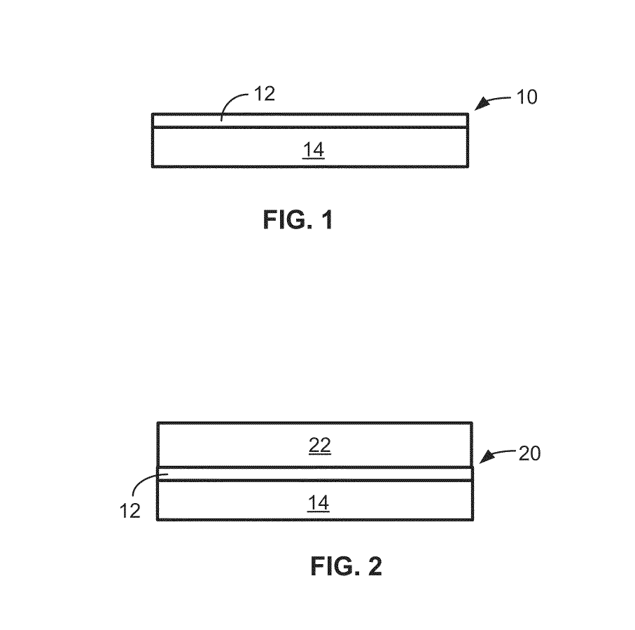

FIG. 1 is schematic diagram of an illustrative polarizing article 10. The polarizing article 10 includes a substrate 14 and a coatable polymer polarizer layer 12 disposed on the substrate 14. The substrate 14 may be any optical element and may be light transmissive. The coatable polymer polarizer layer 12 may be coated directly onto the substrate 14 or the substrate 14 may first be primed and/or corona treated and then the coatable polymer polarizer layer 12 is coated directly onto the primed and/or corona treated substrate 14. The coatable polymer polarizer layer 12 may be coated onto a curved substrate 14 such as a curved display panel or a lens.

The substrate 14 may be glass or a polymer layer such as a polyolefin (PET or PEN), polycarbonate, or polyimide and the like. Glass substrates may form an element of a liquid crystal display panel. The glass substrate may have a reduced thickness such as a 1000 micrometers or less or 500 micrometers or less. In embodiments where the substrate 14 is a polymer layer, the polymer layer may be a flexible film layer that may be processed in a roll-to-roll manufacturing process.

FIG. 2 is a schematic diagram of another illustrative polarizing article 20. The polarizing article 20 includes a substrate 14 and a coatable polymer polarizer layer 12 disposed on the substrate 14 as described above. The polarizing article 20 further includes an optical element 22 disposed on the polarizer layer 12. The polarizer layer 12 separates the substrate 14 from the optical element 22. The additional optical element 22 may be a barrier layer, a hard coat layer, a release layer, an optically clear adhesive layer (or pressure sensitive layer), and the like.

In some embodiments, the coatable polymer polarizer layer 12 may be coated on an adhesive layer and applied to an optical element or substrate.

The rigid rod-like polymers described below that form a lyotropic liquid crystal phase can be dissolved in any useful solvent. The solvent may be aqueous or an organic solvent. The rigid rod-like polymers can be present in the liquid crystal solution in any useful concentration. The rigid rod-like polymers may be present in the liquid crystal solution in an amount from about 0.1% wt to about 50% wt or from about 1% wt to about 40% wt or from about 1% wt to about 35% wt., depending on the particular rigid rod-like polymer and solvent selected.

Rigid rod-like polymers of interest (that can form a coatable polarizer layer) are formed from polymerization of a conjugated molecular segment (I). A chemical formula of conjugated segment (I) is shown below. In the conjugated molecular segment (I), substituent groups R₁, R₂, R₃, and R₄ render the polymer soluble in a solvent: either water or organic solvent. Each of the substituent groups R₁, R₂, R₃, and R₄ is optional and the substituent groups need not be identical to or different from each other. The conjugated molecular segment (I) has a first conjugation length, and a bridging group in between adjacent conjugated molecular segments along a main chain of the rigid rod-like polymer, such that a conjugation length of the rigid rod-like polymer is greater than the first conjugation length. The segment (I) is represented by a structure:

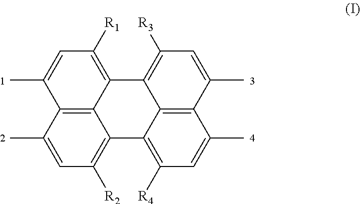

wherein each of R₁, R₂, R₃ and R₄ is independently, hydrogen or a substituent group that renders the rigid rod-like polymer soluble in a solvent and the bridging groups are connected to the conjugated molecular segment (I) at positions 1, 2, 3, and 4.

Conjugated molecular segment (I) has a conjugated electronic system, which extends along the main chain and in a direction perpendicular to the main chain. The extent of the conjugation along the main chain is referred to as the conjugation length. The polymers of interest include a conjugated molecular segment or bridging group that is connected to conjugated molecular segment (I) along the main chain direction. As a result of the proximity of bridging group to segment (I), the conjugation length is greater than the conjugation length of segment (I) by itself.

Some examples of bridging groups BG1, BG2, BG3, and BG4 are shown below.

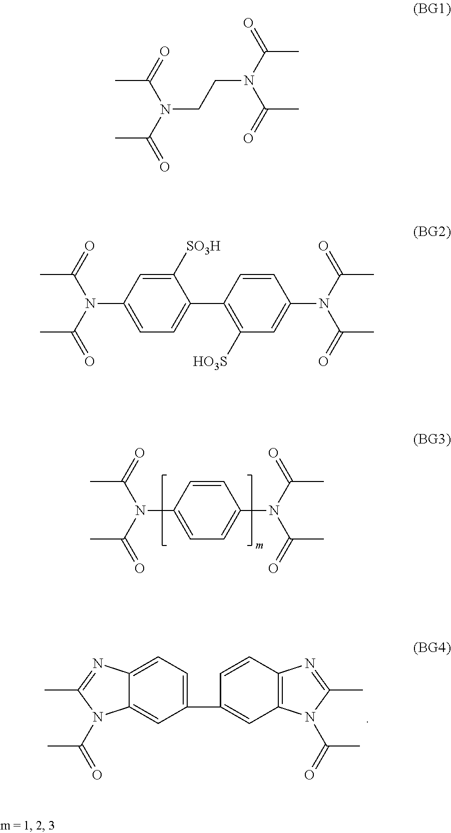

An illustrative rigid rod-like polymer useful for forming the coatable polymer polarizer described herein includes a polymer of a structure:

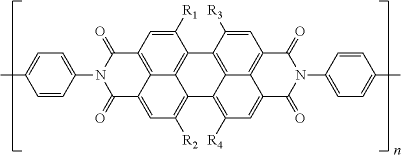

wherein each of R₁, R₂, R₃ and R₄ is independently, hydrogen, hydroxy, SO₃H, O-Ph, or (C1-C12) alkoxy and Ph is phenyl that is unsubstituted or substituted with SO₃H or (C1-C12) alkyl, and n is 2 or greater or from 2 to 20 or from 2 to 10. In many embodiments, at least one of R₁, R₂, R₃ and R₄ is not hydrogen. In many embodiments, at least two of R₁, R₂, R₃ and R₄ are not hydrogen. In some embodiments, at least three of R₁, R₂, R₃ and R₄ are not hydrogen. In some embodiments, all of R₁, R₂, R₃ and R₄ are not hydrogen.

Another illustrative rigid rod-like polymer useful for forming the coatable polymer polarizer described herein includes a polymer of a structure:

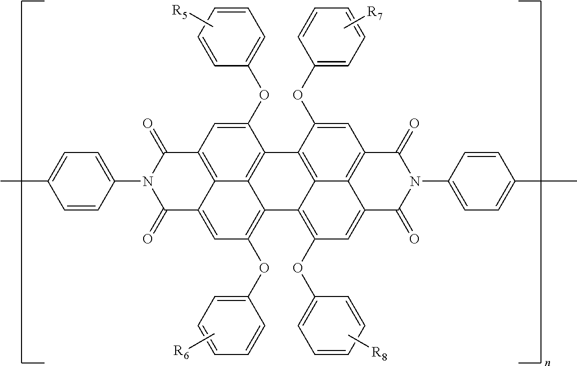

wherein each of R₅, R₆, R₇ and R₈ is independently, hydrogen, hydroxy, SO₃H, (C1-C12) alkoxy or (C1-C12) alkyl, and n is 2 or greater or from 2 to 20 or from 2 to 10. In some embodiments, each of R₅, R₆, R₇ and R₈ is a para(C8)alkyl such as 1,1,3,3-tetra-methyl-butyl group or tert-octyl group or 2-ethyl-hexyl group. In many embodiments, at least one of R₅, R₆, R₇ and R₈ is not hydrogen. In many embodiments, at least two of R₅, R₆, R₇ and R₈ are not hydrogen. In some embodiments, at least three of R₅, R₆, R₇ and R₈ are not hydrogen. In some embodiments, all of R₅, R₆, R₇ and R₈ are not hydrogen.

Another illustrative rigid rod-like polymer useful for forming the coatable polymer polarizer described herein includes a rigid rod-like polymer of a structure:

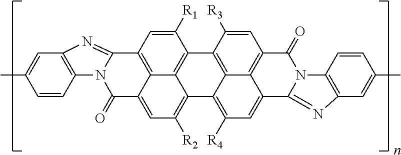

wherein each of R₁, R₂, R₃ and R₄ is independently, hydrogen, hydroxy, SO₃H, O-Ph, or (C1-C12) alkoxy and Ph is phenyl that is unsubstituted or substituted with SO₃H or (C1-C12) alkyl, and n is 2 or greater or from 2 to 20 or from 2 to 10. In many embodiments, at least one of R₁, R₂, R₃ and R₄ is not hydrogen. In many embodiments, at least two of R₁, R₂, R₃ and R₄ are not hydrogen. In some embodiments, at least three of R₁, R₂, R₃ and R₄ are not hydrogen. In some embodiments, all of R₁, R₂, R₃ and R₄ are not hydrogen.

Another illustrative rigid rod-like polymer useful for forming the coatable polymer polarizer described herein includes a polymer of a structure:

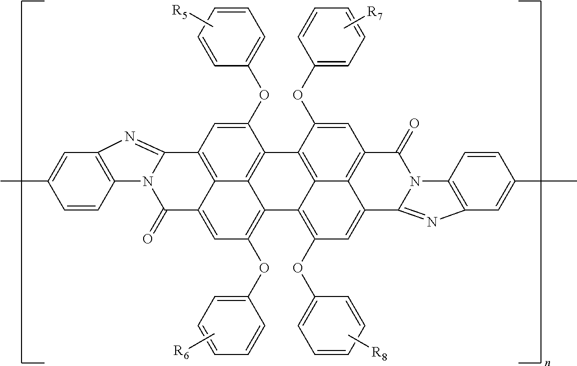

wherein each of R₅, R₆, R₇ and R₈ is independently, hydrogen, hydroxy, SO₃H, (C1-C12) alkoxy or (C1-C12) alkyl, and n is 2 or greater or from 2 to 20 or from 2 to 10. In some embodiments, each of R₅, R₆, R₇ and R₈ is a para(C8)alkyl such as 1,1,3,3-tetra-methyl-butyl group or tert-octyl group or 2-ethyl-hexyl group. In many embodiments, at least one of R₅, R₆, R₇ and R₈ is not hydrogen. In many embodiments, at least two of R₅, R₆, R₇ and R₈ are not hydrogen. In some embodiments, at least three of R₅, R₆, R₇ and R₈ are not hydrogen. In some embodiments, all of R₅, R₆, R₇ and R₈ are not hydrogen.

Examples of synthesis of two monomers (compounds 4 and 5) incorporating segment (I) are shown below. In both cases, the synthesis starts from compound 1, which is commercially available from Sigma-Aldrich Corporation (St. Louis, Mo.). Compound 4 (monomer 4) is obtained by illustrated reaction steps 10, 20, 30, Intermediate compounds 2, 3, and 4, resulting from each of the reactions steps 10, 20, 30, respectively, are shown. Compound 5 (monomer 5) is obtained by reaction 40 starting from compound 2.

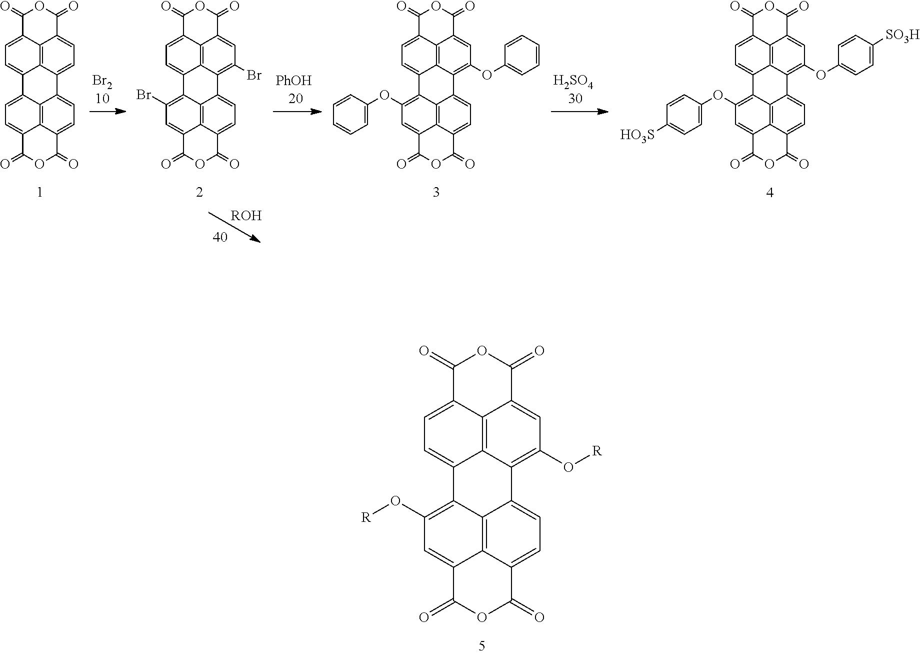

An example of synthesis of a polymer 100 incorporating a conjugated molecular segment (I) and a conjugated molecular segment B or bridging group is connected on both sides of conjugated molecular segment (I) is shown below. The polymer 100 is obtained by reaction 50 starting from monomer 4. The polymer 100 has substituent groups R₁, R₄ chosen to make the polymer water-soluble. Substituent groups R₂, R₃ are not substituted.

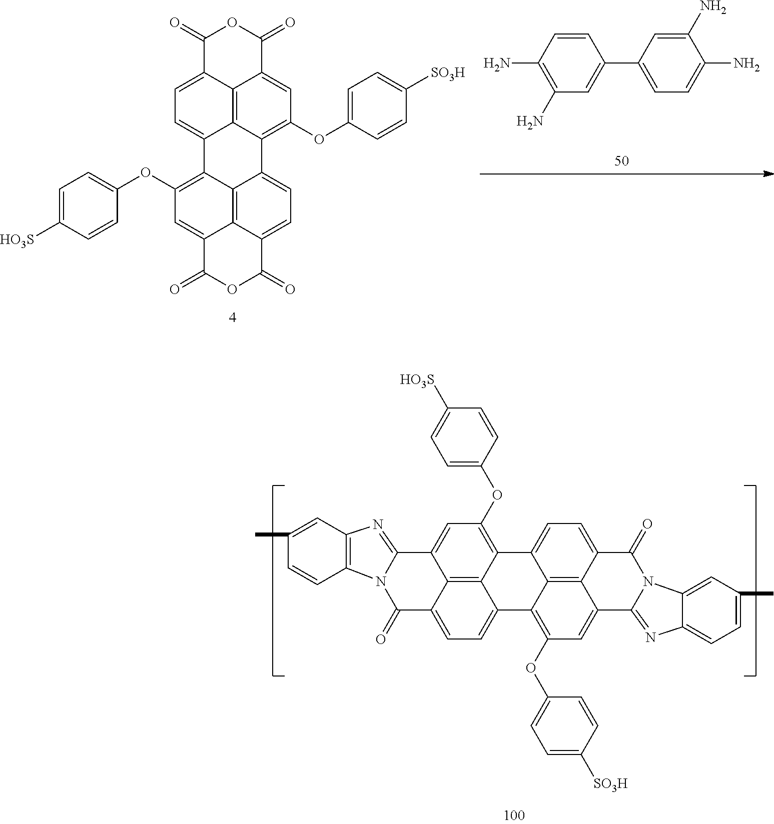

An example of synthesis of a polymer 200 incorporating a conjugated molecular segment (I) and a conjugated molecular segment B or bridging group is connected on both sides of conjugated molecular segment (I) is shown below. The polymer 200 is obtained by reaction 60 starting from monomer 5. In the cases where R is chosen to be an alkyl group, the polymer 200 is designed to be soluble in organic solvents. The conjugated molecular segment B or bridging group is identical to that in polymer 100.

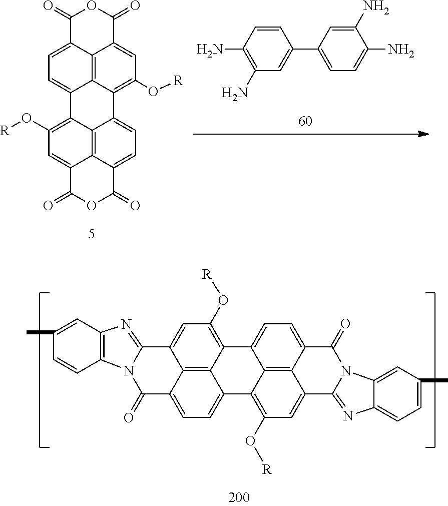

An example of synthesis of a polymer 300 incorporating a conjugated molecular segment (I) and a conjugated molecular segment B or bridging group is connected on both sides of conjugated molecular segment (I) is shown below. The polymer 300 is obtained by reaction 70 starting from monomer 5, similar to polymer 200. In the cases where R is chosen to be an alkyl group, the polymer 300 is designed to be soluble in organic solvents. The conjugated molecular segment B or bridging group is different from that in polymers 100 and 200.

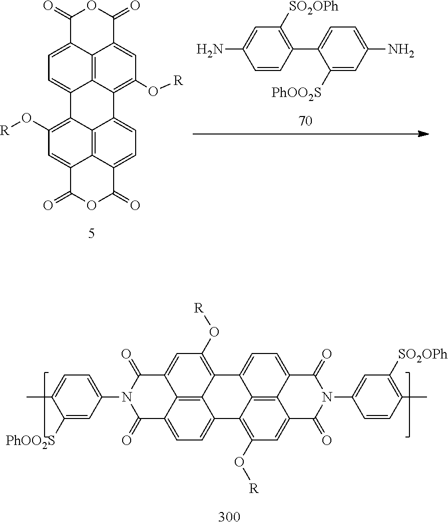

Exemplary polymers 100, 200, 300 can each form a coatable polarizer layer, as described herein.

### Examples

Examples of synthesis of two rigid rod polymers (having repeating and 9) incorporating segment (I) are shown below.

In both cases, the synthesis starts from compound (1) dianhydride of 3,4,9,10-perylene tetracarboxylic acid (DA PTCA), which is commercially available from Sigma-Aldrich Corporation (St. Louis, Mo.). All chemicals listed are commercially available from Sigma-Aldrich Corporation (St. Louis, Mo.).

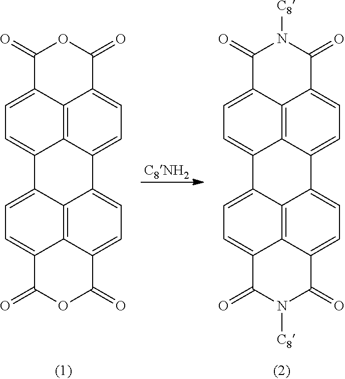

Compound (2) N,N′-Di-(2-ethylhexyl) Perylene 3,4:9,10 bis(dicarboximide) is formed by: 50 g (131 mmol) of ground compound (1) and 214 ml (1.31 mol) of 2-ethylhexylamine was added to 1100 ml of anhydrous N-methylpyrrolidone. This mixture was agitated at 150-160 degrees C. for 5 hrs under Argon. Then the reaction mass was poured into 8 L of 1M HCl, the suspension was filtered and the filter cake washed consequently with 500 ml of water, 1 L of 5% NaOH and then with 7 L of water. Finally the material was dried at 95-100 degrees C. for 48 hrs. Yield of compound (2) is 78 g. C_{8′} refers to 2-ethyl-hexyl.

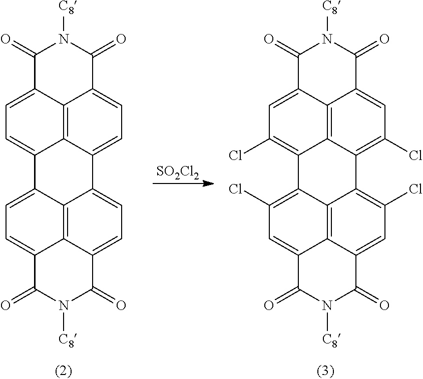

Compound (3) N,N′-Di-(2-ethylhexyl) 1,6,7,12-tetrachloro-Perylene 3,4:9,10 bis(dicarboximide) is formed by: 62 g of compound (2) was added to 375 ml of Nitrobenzene, the mixture was heated to 80-85 degrees C., then 4.13 g of Iodine and 4.13 g of Iodobenzene were added and the resulting mixture was agitated at 80-85 degrees C. for 1.5 hrs. 51.5 ml of Sulfuryl Chloride was added dropwise within an hour and heating continued for 18 hours. After cooling to room temperature the reaction mass was added by small portions to 2200 ml of Methanol with good agitation. The product was isolated by filtration and dried at 100 degrees C. for 2 days. Yield of compound (3) is 72 g.

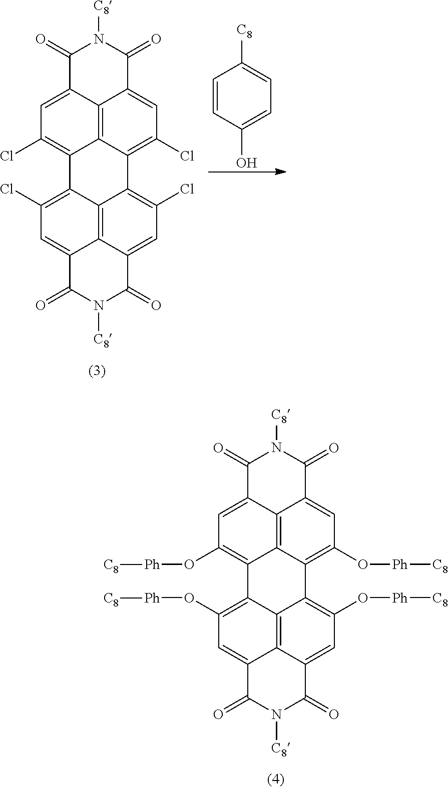

Compound (4) N,N′-Di-(2-ethylhexyl) 1,6,7,12-tetra-(tert-octyl-Phenoxy)-Perylene 3,4:9,10 bis(dicarboximide) is formed by: 5.0 g (6.67 mmol) of well ground compound (3) was added to 270 ml of anhydrous DMF followed by 11.5 g (55.8 mmol) of p-tert-Octyl-Phenol and 8.6 g (26.6 mmol) of anhydrous Cesium Carbonate. The resulting suspension was heated to 110 degrees C. under constant flow of Argon for 29 hrs. Then the reaction mass was added to 1 L of 1% HCl with agitation, the product was extracted with 300 ml of Chloroform, washed with 800 ml of water, the Chloroform layer dried with anhydrous Sodium Sulfate and evaporated. The dry material was purified using liquid chromatography (Silica Gel, Chloroform/Petroleum Ether/Isopropyl Alcohol/Ethyl Acetate=60/35/2.5/2.5). Yield of solid compound (4) is 6.8 g. The group “Ph” refers to phenylene or para-phenylene, the group “C₈” refers to: 1,1,3,3-tetra-methyl-butyl-; or tert-octyl-group; the group “C_{8′}” refers to 2-ethyl-hexyl.

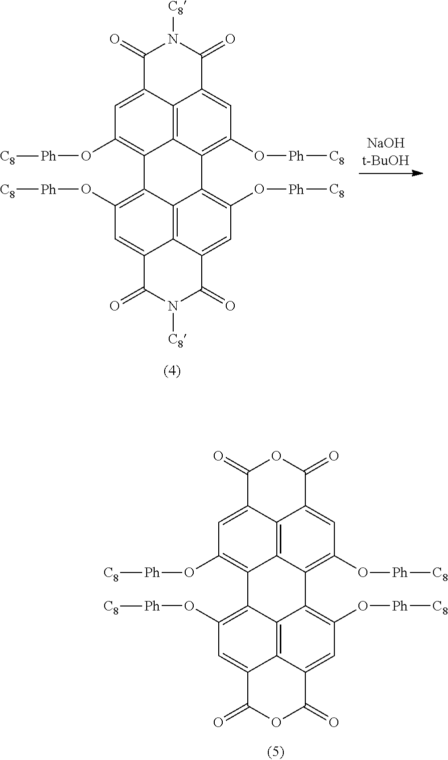

Compound (5) 1,6,7,12-tetra-(tert-octyl-Phenoxy)-3,4,9,10 Perylenetetracarboxylic acid Dianhydride is formed by: 200 ml of Tert-Butyl Alcohol, 6.8 g of compound (4), 10.5 g of Potassium Hydroxide and 0.6 g of Water were mixed and heated with stirring for 18 hrs under reflux. The resulting green solution was poured into 450 ml of Acetic Acid and stirred for 4 hrs. The solid part was isolated by filtration and the filter cake was washed with 100 ml of 1% HCl and 500 ml of water and vacuum dried. Yield of solid (5) is 5.6 g.

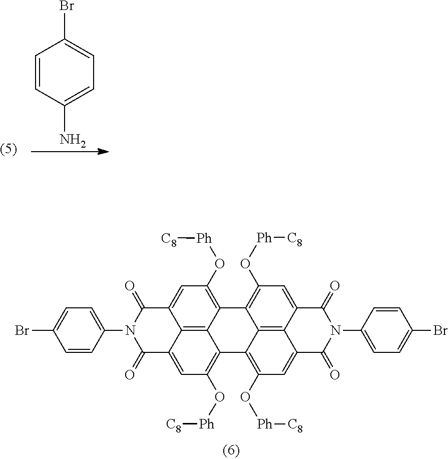

Compound (6) N,N′-Di-(4-Bromophenyl) 1,6,7,12-tetra-(tert-Octyl-Phenoxy)-Perylene 3,4:9,10 bis(dicarboximide) is formed by: 1.2 g of compound (5) and 1.7 g of 4-Bromo-aniline were added to 25 ml of Propionic acid and heated with agitation under Ar blanket to 100 degrees C. and kept at that temperature for 1 hr. Then the temperature was increased to 140 degrees C. and maintained for 15 hrs. Then the reaction mass was allowed to cool to 40 C, poured into 200 ml of water and agitated for 3 hrs. The solid part was isolated by filtration and the filter cake washed with 500 ml of 5% HCl, then with 100 ml of water followed by 250 ml of 5% NaHCO₃ and then with 150 ml of water. The material was dried at 85 degrees C. in vacuum oven overnight. Purification was done using LC technique as described for compound (4). Yield of solid (6) is 0.7 g.

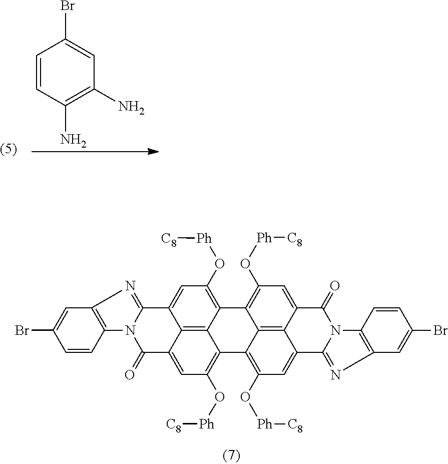

Compound (7) Di-(3-Bromobenzimidazole) of 1,6,7,12-tetra-(tert-Octyl-Phenoxy)-3,4,9,10 Perylenetetracarboxylic acid is formed by: 0.67 g of compound (5), 0.52 g of 4-Bromo-1,2-diaminobenzene and 0.1 g of Zinc Sulfate monohydrate were added to 7 ml of N-methylpyrrolidone and the mixture was held for 20 hrs at 200 degrees C. The product was isolated by filtration and washed with 90 ml of water, 100 ml of 1% HCl, 50 ml of Sodium Bicarbonate and 200 ml of water and dried at 90 degrees C. Purification was done using LC technique as described for compound (4). Yield of solid (7) is 0.4 g.

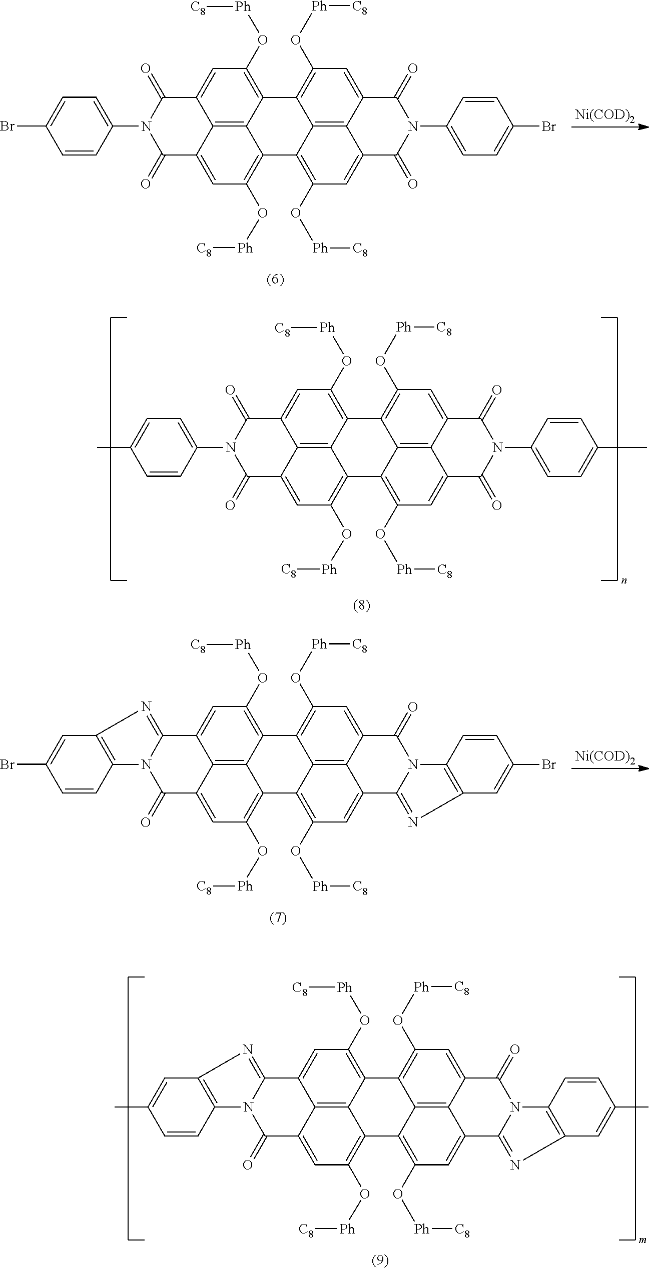

Polymers (8,9)—All of the following manipulations were carried out in the dark under Argon atmosphere in a glovebox. A solution of 0.132 g (0.48 mmol) Bis(cyclooctadiene)nickel(0), 0.075 g (0.48 mmol) 2,2′-Bipyridyl and 0.052 g (0.48 mmol) cyclooctadiene in 2 ml of dry DMF and 4 ml of dry Toluene was heated to 60 degrees C. and in 30 min a solution of 0.304 g (0.2 mmol) of compound (6) or 0.304 g (0.2 mmol) of compound (7) in 9 ml of dry Toluene was added. The reaction temperature was increased to 85 degrees C. and the mass was kept agitated at temperature for 72 hrs. Then the reaction mass was cooled, poured into 100 ml of 1% HCl solution, the solid part was filtered and treated with 100 ml of saturated solution of EDTA and dried. The molecular weight determined by GPC analysis was in the range of 3000-12000.

Coating Solutions

Coating solutions were prepared by making saturated solutions of polymers (8) and (9) in Chlorobenzene or Chloroform or Toluene.

### Example 1

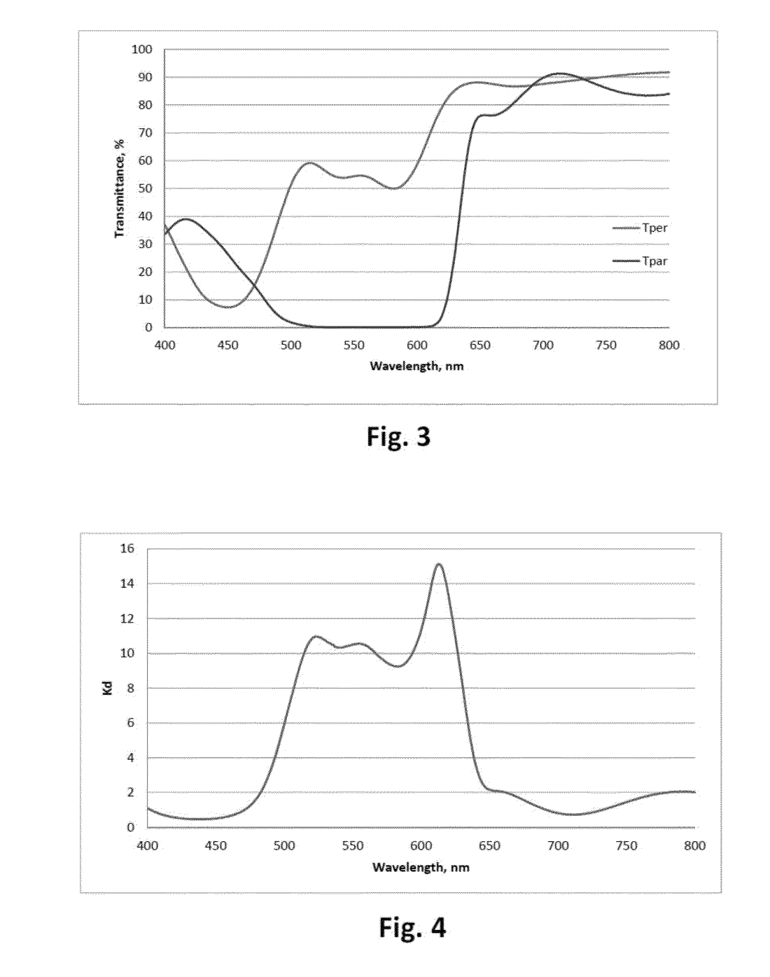

The coating solution of polymer (8) at 4% solids by weight in chlorobenzene was coated onto a glass substrate. The dry thickness was 720 nm. Transmittance spectra was taken for two orientations of the sample (coating direction perpendicular (Tper) and parallel (Tpar) to the axis of the polarizer) analyzed and graphed at FIG. 3.

The Dichroic ratio was calculated as ln(Tpar)/In(Tper) and graphed at FIG. 4. The coatable polymer polarizer works in the 500-600 nm range of wavelengths with a peak at 612 nm of Kd=15, which is in correlation with the general absorption spectrum of the material. Maximum polarization efficiency was calculated 99.4% at 536 nm.

Thus, embodiments of COATABLE POLYMER POLARIZER are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

What is claimed is:

1. A composition comprising:
a rigid rod-like polymer capable of forming a liquid crystal phase in a solvent, the rigid rod-like polymer comprises:
a conjugated molecular segment (I), having a first conjugation length; and
a bridging group in between adjacent conjugated molecular segments along a main chain of the rigid rod-like polymer, such that a conjugation length of the rigid rod-like polymer is greater than the first conjugation length, wherein segment (I) is represented by a structure: 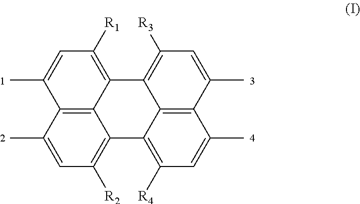
wherein each of R₁, R₂, R₃ and R₄ is independently, hydrogen or a substituent group that renders the rigid rod-like polymer soluble in a solvent and the bridging groups are connected to the conjugated molecular segment (I) at positions 1, 2, 3, and 4.

2. The composition of claim 1 wherein the rigid rod-like polymer comprises repeating segments of a structure: 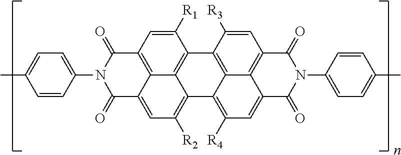
wherein each of R₁, R₂, R₃ and R₄ is independently, hydrogen, hydroxy, SO₃H, O-Ph, or (C1-C12) alkoxy and Ph is phenyl that is unsubstituted or substituted with SO3H or (C1-C12) alkyl, and n is 2 or greater.

3. The composition of claim 1 wherein the rigid rod-like polymer comprises repeating segments of a structure: 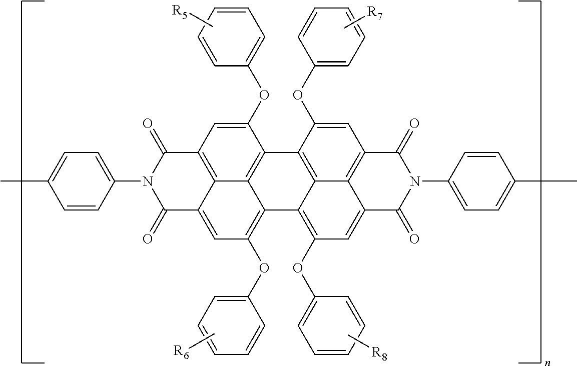
wherein each of R₅, R₆, R₇ and R₈ is independently, hydrogen, hydroxy, SO₃H, (C1-C12) alkoxy or (C1-C12) alkyl, and n is 2 or greater.

4. The composition of claim 3 wherein each of R₅, R₆, R₇ and R₈ is (C8) alkyl.

5. The composition of claim 1 wherein the rigid rod-like polymer comprises repeating 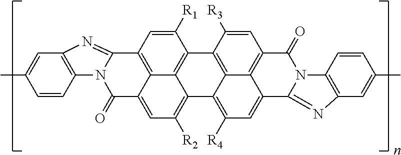
segments of a structure:
wherein each of R₁, R₂, R₃ and R₄ is independently, hydrogen, hydroxy, SO₃H, O-Ph, or (C1-C12) alkoxy and Ph is phenyl that is unsubstituted or substituted with SO₃H or (C1-C12) alkyl, and n is 2 or greater.

6. The composition of claim 1 wherein the rigid rod-like polymer comprises repeating segments of a structure: 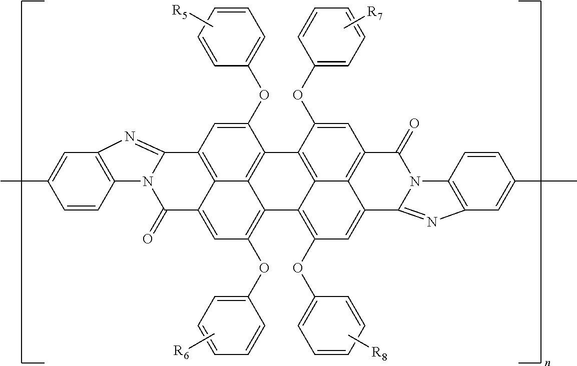
wherein each of R₅, R₆, R₇ and R₈ is independently, hydrogen, hydroxy, SO₃H, (C1-C12) alkoxy or (C1-C12) alkyl, and n is 2 or greater.

7. The composition of claim 6 wherein each of R₅, R₆, R₇ and R₈ is (C8) alkyl.

8. The composition of claim 1 further comprising a solvent and the rigid rod-like polymer forming a liquid crystal phase solution with the solvent.

9. The composition of claim 8 wherein the solvent is aqueous.

10. A polarizer comprising:
a layer of aligned polymer material formed from a lyotropic liquid crystal material, the layer of aligned polymer material transmitting most of visible light of a first polarization and absorbing most of visible light having a second polarization orthogonal to the first polarization, the layer having a thickness of less than five micrometers.

11. The polarizer according to claim 10, wherein the layer has a thickness of less than one micrometer.

12. The polarizer according to claim 10, wherein the layer of aligned polymer material is achromatic.

13. The polarizer according to claim 10, wherein the aligned polymer material comprises a rigid rod-like polymer comprising:
a conjugated molecular segment (I), having a first conjugation length; and
a bridging group in between adjacent conjugated molecular segments along a main chain of the rigid rod-like polymer, such that a conjugation length of the rigid rod-like polymer is greater than the first conjugation length, wherein segment (I) is represented by a structure: 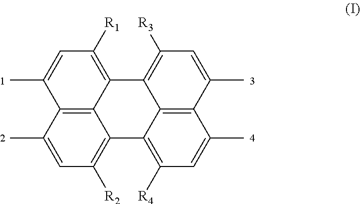
wherein each of R₁, R₂, R₃ and R₄ is independently, hydrogen or a substituent group that renders the rigid rod-like polymer soluble in a solvent and the bridging groups are connected to the conjugated molecular segment (I) at positions 1, 2, 3, and 4.

14. The polarizer of claim 13 wherein the rigid rod-like polymer comprises repeating segments of a structure: 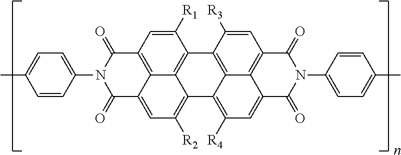
wherein each of R₁, R₂, R₃ and R₄ is independently, hydrogen, hydroxy, SO₃H, O-Ph, or (C1-C12) alkoxy and Ph is phenyl that is unsubstituted or substituted with SO3H or (C1-C12) alkyl, and n is 2 or greater.

15. The polarizer of claim 13 wherein the rigid rod-like polymer comprises repeating 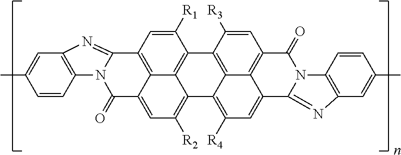
segments of a structure:
wherein each of R₁, R₂, R₃ and R₄ is independently, hydrogen, hydroxy, SO₃H, O-Ph, or (C1-C12) alkoxy and Ph is phenyl that is unsubstituted or substituted with SO₃H or (C1-C12) alkyl, and n is 2 or greater.

16. An article comprising:
a substrate; and
the polarizer of claim 10 disposed on the substrate.

17. The article of claim 16, wherein the substrate is a light transmissive layer.

18. The article of claim 16, further comprising an optical element disposed on the polarizer and the polarizer separating the substrate from the optical element.

19. The article of claim 16, wherein the substrate is curved.

20. A method of forming an achromatic polarizer comprising the steps of:
shear coating a lyotropic liquid crystal polymer material onto a substrate to form an aligned liquid crystal polymer layer;
drying the aligned liquid crystal polymer layer to form a layer of aligned polymer material layer, and the aligned polymer material layer transmitting most of visible light of a first polarization and absorbing most of visible light having a second polarization orthogonal to the first polarization, the aligned polymer material layer having a thickness of less than five micrometers.
